(19) United States
(12) Patent Application Publication
(10) Pub. No.: US 2014/0360327 A1
(43) Pub. Date: Dec. 11, 2014

(54) BEVERAGE PREPARATION MACHINE

(71) Applicant: Kraft Foods R&D, Inc., Deerfiedl, IL (US)

(72) Inventors: Rebecca Dingle, Thundersley (GB); Oliver Masters, Glastonbury (GB)

(21) Appl. No.: 14/372,719

(22) PCT Filed: Jan. 29, 2013
(86) PCT No.: PCT/IB2013/000207

§ 371 Date: Jul. 16, 2014

(30) Foreign Application Priority Data
Feb. 2, 2012 (GB) 1201838.8

(51) Int. Cl. A47J 31/44; A47J 31/40

(52) U.S. Cl. CPC A47J 31/446; A47J 31/407
USPC 83/54; 83/467.1

(57) ABSTRACT

A clamping mechanism for a beverage preparation machine is provided comprising: a support; a holder for a beverage cartridge; and a clamp. The holder capable of being coupled to and decoupled from the support. Wherein the holder is rotatable about a first axis of the clamping mechanism between: i) a first position, in which the holder is able to be coupled to or decoupled from the support and the holder and clamp are relatively spaced apart in the direction of the first axis; and ii) a second position in which the holder is retained to the support and the holder and clamp are relatively close to one another in the direction of the first axis such that a beverage cartridge held in use in the holder is clamped between the holder and the clamp. Wherein the clamping mechanism further comprises an inlet piercer for forming an inlet in the beverage cartridge. Wherein the inlet piercer forms part of or is coupled to, the clamp and is able to rotate with the holder about the first axis.

The present disclosure relates to beverage preparation machines and, in particular, to clamping mechanisms and methods of such beverage preparation machines.

Beverage preparation machines which produce beverages through contact of an aqueous medium with one or more beverage ingredients are known for the production of beverages such as coffee, hot chocolate and other soft drinks. An example of one such machine is disclosed in EP 1 440 910 which uses sealed beverage cartridges containing beverage ingredients. In use the beverage cartridge is inserted into a pivotable cartridge mount of the beverage preparation machine, clamped and an inlet and outlet are formed in a sealing laminate of the beverage cartridge to allow entry of heated water and discharge of the formed beverage. The clamping of the beverage cartridge requires the closure of a cartridge head by rotating downwardly an upper part against a fixed lower part to clamp the beverage cartridge and pivotable cartridge mount therebetween.

The present disclosure relates to an alternative clamping mechanism and method.

Accordingly, in one aspect there is provided a clamping mechanism for a beverage preparation machine comprising:

a support;

a holder for a beverage cartridge; and

a clamp;

the holder capable of being coupled to and decoupled from the support;

wherein the holder is rotatable about a first axis of the clamping mechanism between:
i) a first position, in which the holder is able to be coupled to or decoupled from the support and the holder and clamp are relatively spaced apart in the direction of the first axis; and
ii) a second position in which the holder is retained to the support and the holder and clamp are relatively close to one another in the direction of the first axis such that a beverage cartridge held in use in the holder is clamped between the holder and the clamp;

wherein the clamping mechanism further comprises an inlet piercer for forming an inlet in the beverage cartridge, wherein the inlet piercer forms part of, or is coupled to, the clamp so as to rotate with the clamp about the first axis.

The support may comprise a fixed support part and a rotatable support part; the holder being able to be coupled to or decoupled from the rotatable support part.

Optionally:

i) the clamp may be coupled to the rotatable support part so as to be rotational fixed thereto but able to move relative thereto in the direction of the first axis;

ii) the rotatable support part may be rotatable relative to the fixed support part but fixed relative thereto in the direction of the first axis; and

iii) the clamp may be coupled to the fixed support part so as to be movable relative thereto both in the direction of the first axis and rotationally.

Optionally:

i) the rotatable support part may comprise one or more axial guide slots orientated in the direction of the first axis and the clamp may comprise one or more pegs which are slidingly received in the one or more axial guide slots;

ii) the fixed support part may comprise one or more curved guide slots in which the one or more pegs of the clamp are slidingly received.

Consequently, with such an arrangement rotation of the holder about the first axis can result in the clamp and the holder being movable relative to one another along the direction of the first axis.

The holder may be rotatable about the first axis in a plane substantially perpendicular to the first axis and wherein during rotation between the first and second positions the holder may remain in said plane without moving along the first axis. Advantageously, this arrangement allows the holder to move in a single plane as it is rotated. This is an easier movement for a user to carry out than a helical movement where the holder both rotates and travels along the direction of the first axis. The movement is also more aesthetically pleasing.

The holder and clamp may be coupled to the support such that on rotation of the holder between the first and second positions the clamp is moved in the direction of the first axis.

The clamping mechanism may further comprise a beverage cartridge support which forms a part of, or is coupled to, the holder; the beverage cartridge support being movable between:
i) a loading position in which, with the holder coupled to the support in the first position, the beverage cartridge support is inclined relative to a plane substantially perpendicular to the first axis; and
ii) a clamped position in which, with the holder coupled to the support in the second position, the beverage cartridge support is in the plane substantially perpendicular to the first axis.

The inlet piercer may be off-set from the centre of the clamp such that the inlet piercer follows an arc path as the clamp rotates about the first axis. Advantageously, since the inlet piercer moves with the clamp (and holder) the beverage cartridge does not rotate relative to the inlet piercer about the first axis as the holder and clamp are rotated about the first axis. This allows the inlet piercer to pierce a hole in the beverage cartridge which substantially matches the outer profile of the inlet piercer, rather than cutting an arc shaped slot.

The clamping mechanism may further comprise an outlet piercer for forming an outlet in the beverage cartridge, wherein the outlet piercer forms part of, or is coupled to, the holder so as to rotate with the holder between the first and second positions. As with the inlet piercer, the outlet piercer does not rotate about the first axis relative to the beverage cartridge on rotation of the holder about the first axis.

There is also provided a method of clamping a beverage cartridge in a beverage preparation machine comprising the steps of:

inserting the beverage cartridge into a holder;

coupling the holder to a support;

rotating the holder and inlet piercer about a first axis;

said rotation causing the holder and a clamp to move relatively closer to one another in the direction of the first axis so as to engage the beverage cartridge with the clamp and so clamp the cartridge between the clamp and the holder; and

piercing an inlet in the cartridge using an inlet piercer which rotates with the clamp about the first axis.

The holder may be rotated in a plane substantially perpendicular to the first axis and wherein during rotation the holder remains in said plane without moving along the first axis.

The beverage cartridge may be initially supported in the holder in an inclined orientation such that with the holder coupled to the support the beverage cartridge is inclined relative to a plane substantially perpendicular to the first axis; wherein on rotation of the holder the clamp forces the beverage cartridge to rotate about a second axis perpendicular to the first axis so to lie in the plane substantially perpendicular to the first axis.

The holder may further comprise an outlet piercer, the inlet piercer and outlet piercer piercing opposite sides of the beverage cartridge, the holder comprising an inlet piercer.

In another aspect there is provided a clamping mechanism for a beverage preparation machine comprising:

a support;

a holder for a beverage cartridge; and

a clamp;

the holder capable of being coupled to and decoupled from the support and comprising a beverage cartridge support;

the holder being rotatable about a first axis of the clamping mechanism between:
i) a loading position in which the holder and clamp are relatively spaced apart in the direction of the first axis wherein the beverage cartridge support of the holder is inclined relative to a plane substantially perpendicular to the first axis; and
ii) a clamped position in which the holder and clamp are relatively close to one another in the direction of the first axis wherein the beverage cartridge support has been moved into the plane substantially perpendicular to the first axis.

Advantageously, the presence of the beverage cartridge support enables the orientation of the beverage cartridge relative to the remainder of the holder to change during rotation of the holder about the first axis.

Preferably:

i) the holder comprises a body having a base and a side wall so as to define a cavity; and

ii) the beverage cartridge support is located within the cavity.

The movement of the beverage cartridge support on rotation of the holder about the first axis allows the timing of the piercing of the inlet in the beverage cartridge to be accurately controlled.

The beverage cartridge support may be pivotally coupled to the holder so as to be rotatable between the loading and clamped positions.

The beverage cartridge support may be biased into the position in which it is inclined relative to the plane substantially perpendicular to the first axis.

The holder may further comprise an outlet piercer extending upwardly from the base. The movement of the beverage cartridge support on rotation of the holder about the first axis allows the timing of the piercing of the inlet relative to the outlet to be controlled. For example the inlet may be pierced before the outlet.

There is also provided a beverage preparation system comprising a beverage preparation machine and a beverage cartridge, wherein the beverage preparation machine comprises a clamping mechanism as described in any of the above aspects.

In any of the above aspects:
the outlet piercer may be formed as an integral part of the holder. Alternatively it may be disconnectable from the remainder of the holder;
the inlet piercer may be formed as an integral part of the clamp. Alternatively it may be disconnectable from the remainder of the clamp;
the holder may comprise a handle to assist its rotation;
the first axis may be vertical or substantially vertical;
the holder may thus rotate in a horizontal or substantially horizontal plane;
the holder may rotate through approximately 90 degrees between its first and second positions;
the holder may be coupled to the support using a horizontal movement;
the beverage cartridge support in its loading position, may be inclined such that a beverage cartridge supported by the beverage, cartridge support is held clear of the inlet and/or outlet piercer;
the beverage cartridge support may comprise an aperture allowing a portion of the beverage cartridge to be viewed therethrough, for example by a barcode reader of the beverage preparation machine;
the beverage cartridge support may be detachable from the holder;
the beverage cartridge support may comprise a support plate by which the beverage cartridge is supported and an elongated arm, wherein a distal end of the elongated arm forms a pivotable connection with the holder;
the elongated arm may be shaped such that in the clamped position the elongated arm is flexed, such that on release from the clamped position, the elongated arm biases the support plate into its inclined position.

Aspects of the present disclosure will now be described, by way of example only, with reference to the accompanying drawings, in which;

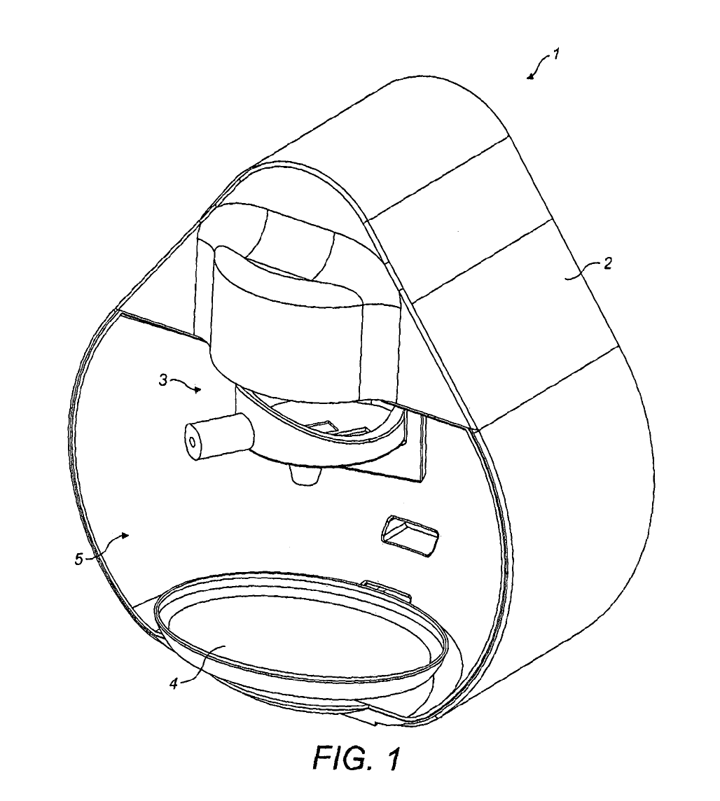

FIG. 1 is a perspective view of a beverage preparation machine according to the present disclosure;

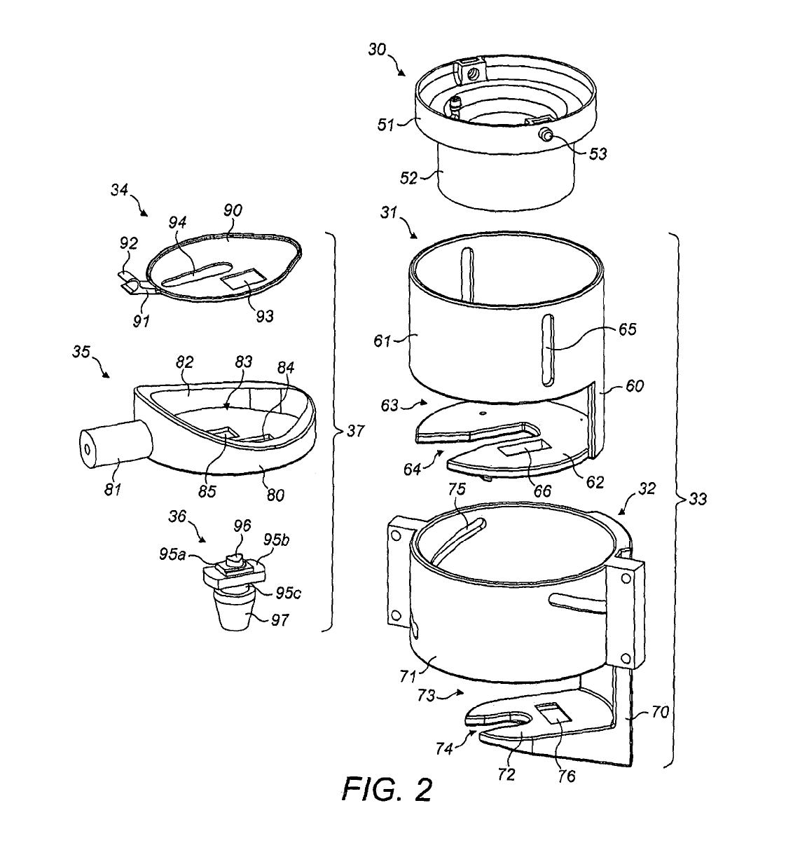

FIG. 2 is an exploded perspective view of a clamping mechanism of the beverage preparation machine in FIG. 1;

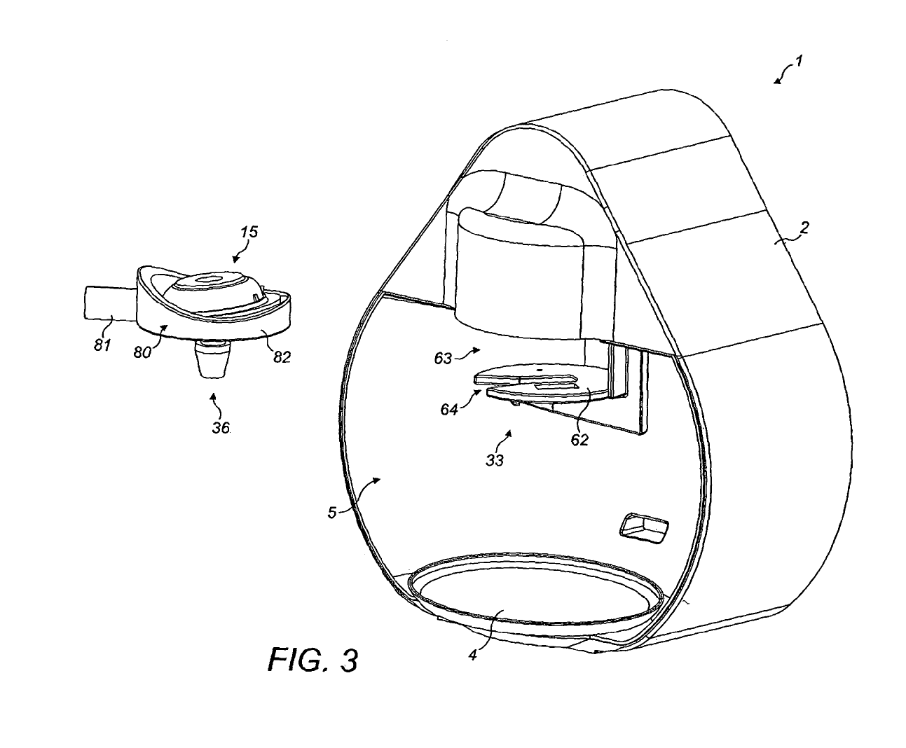

FIG. 3 is a perspective view of the beverage preparation machine of FIG. 1 with a holder of the clamping mechanism being uncoupled and containing a beverage cartridge;

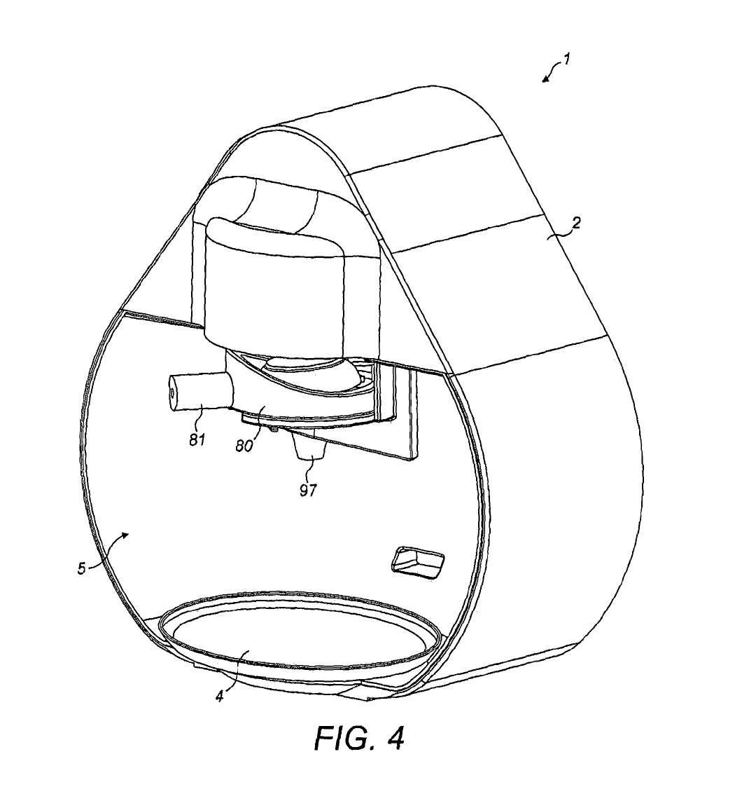

FIG. 4 is a perspective view of the beverage preparation machine FIG. 1 with a beverage cartridge with the holder in a first position;

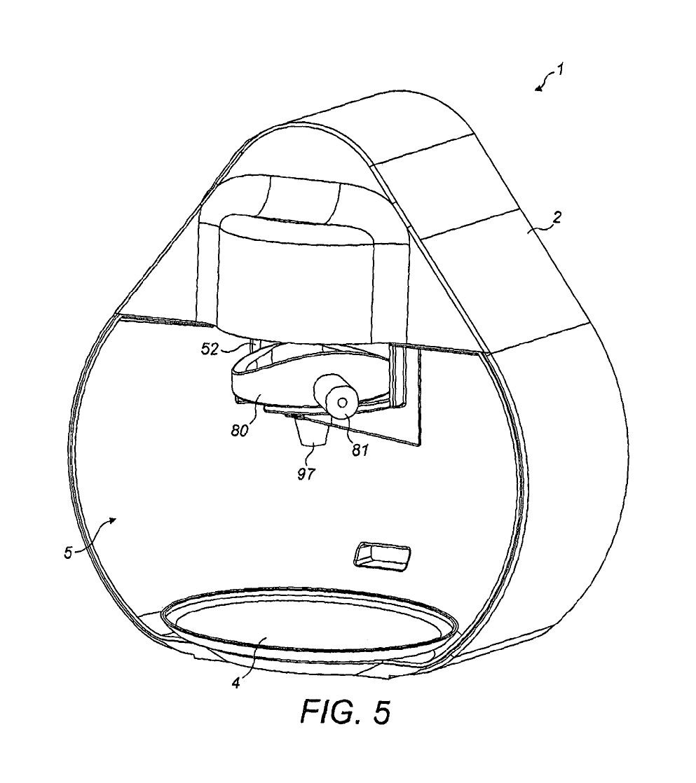

FIG. 5 is a perspective view similar to FIG. 4 with the holder in a second position;

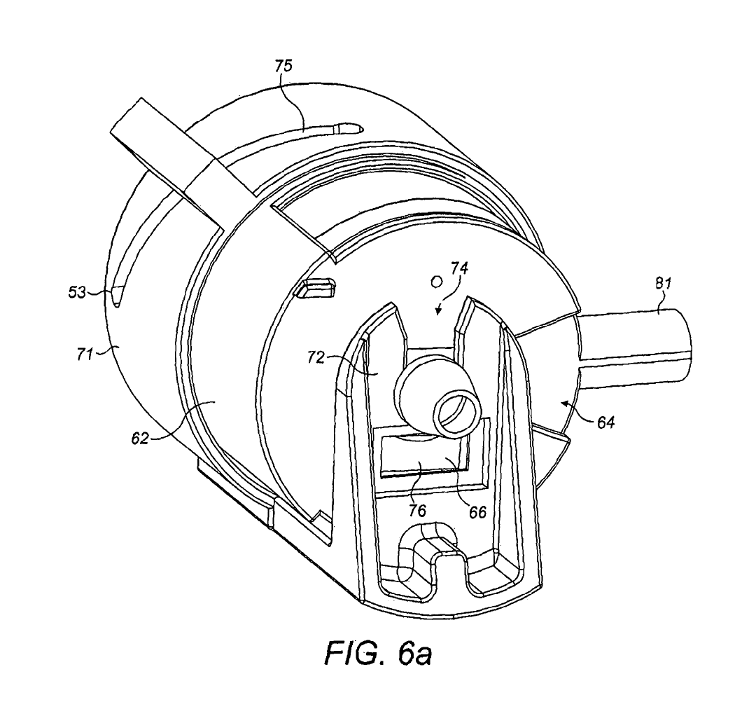

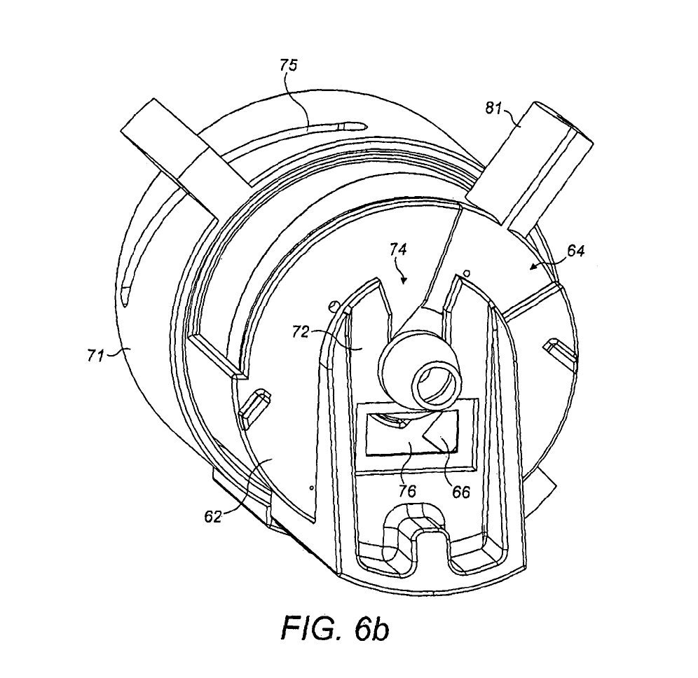

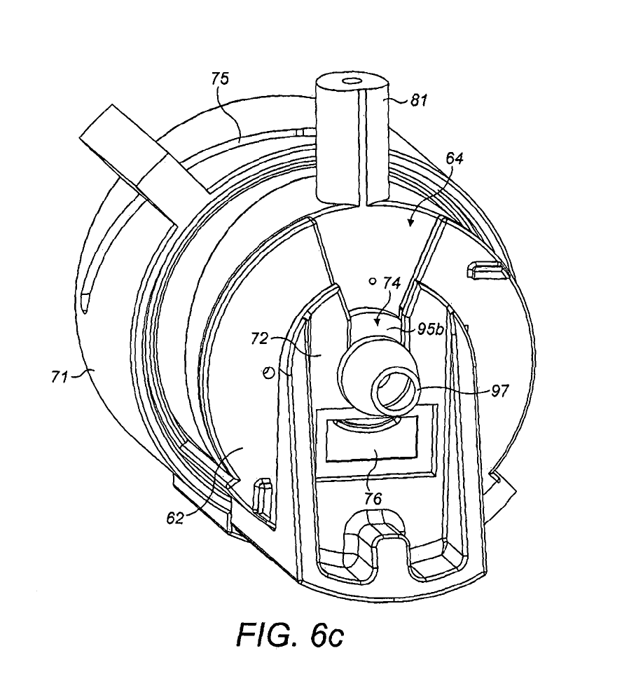

FIG. 6a is a perspective view from underneath of the clamping mechanism showing the holder in the second position;

FIG. 6b is a similar view to FIG. 6a showing the holder intermediate the first and second positions;

FIG. 6c is a perspective view similar to FIG. 6a showing the holder in the first position;

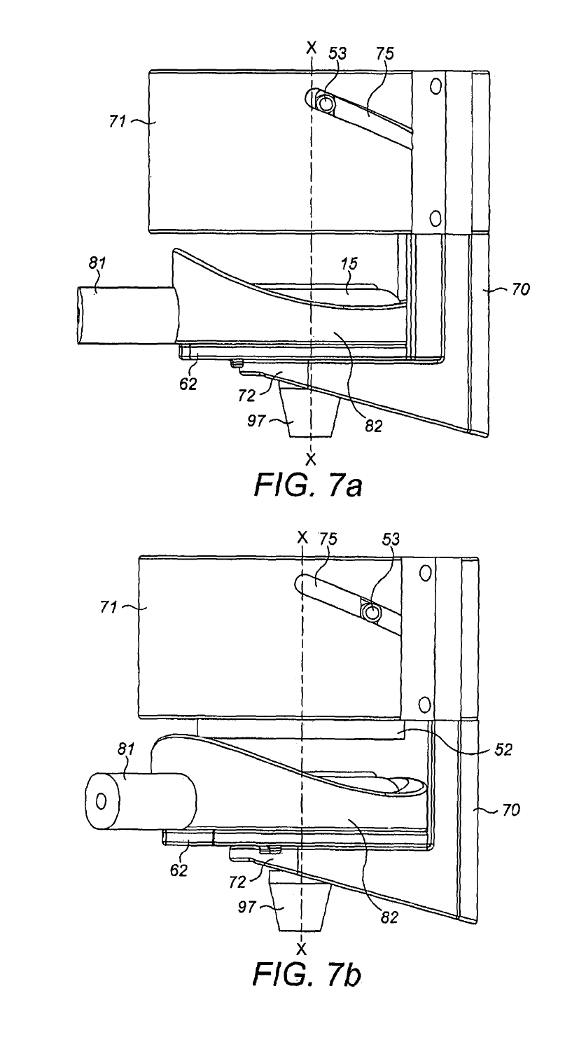

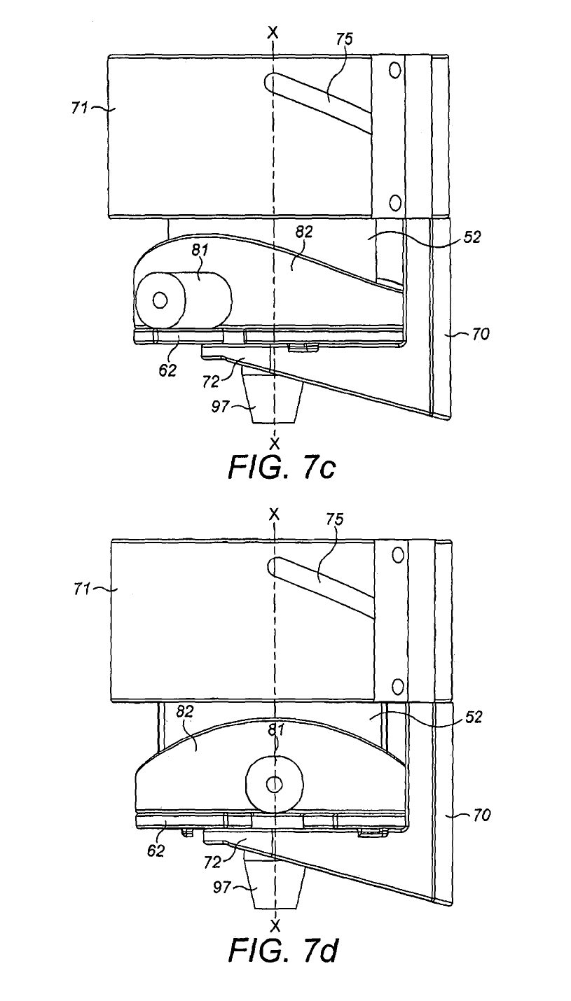

FIG. 7a is a side view of the clamping mechanism of FIG. 2 with the holder in the first position;

FIG. 7b and FIG. 7c are similar views to FIG. 7a showing the holder intermediate the first and second positions;

FIG. 7d is a view similar to FIG. 7a showing the holder in the second position;

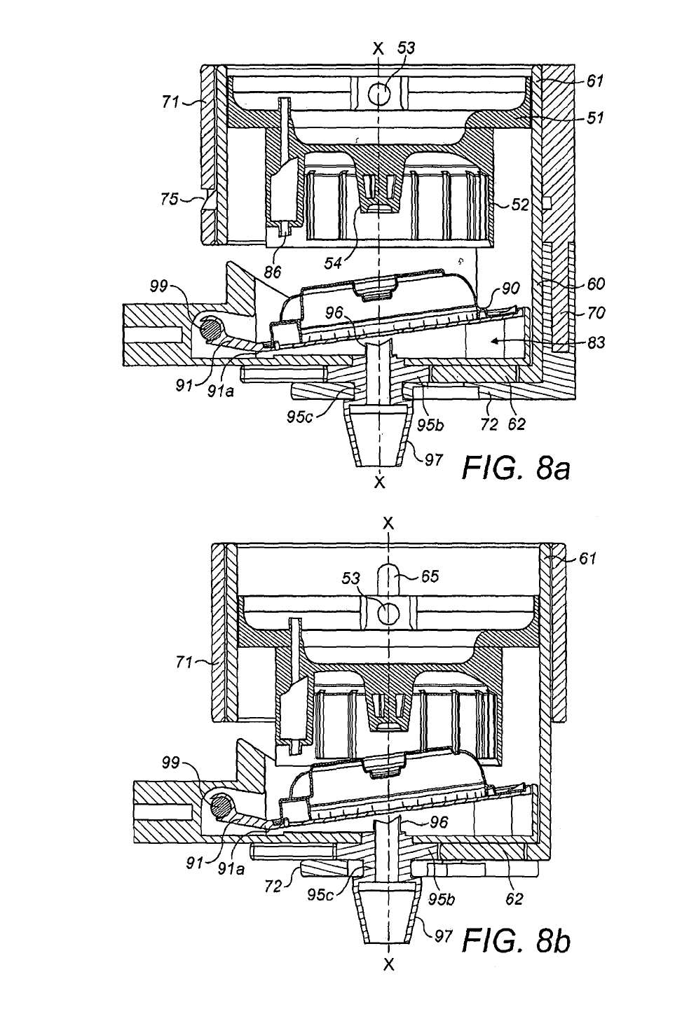

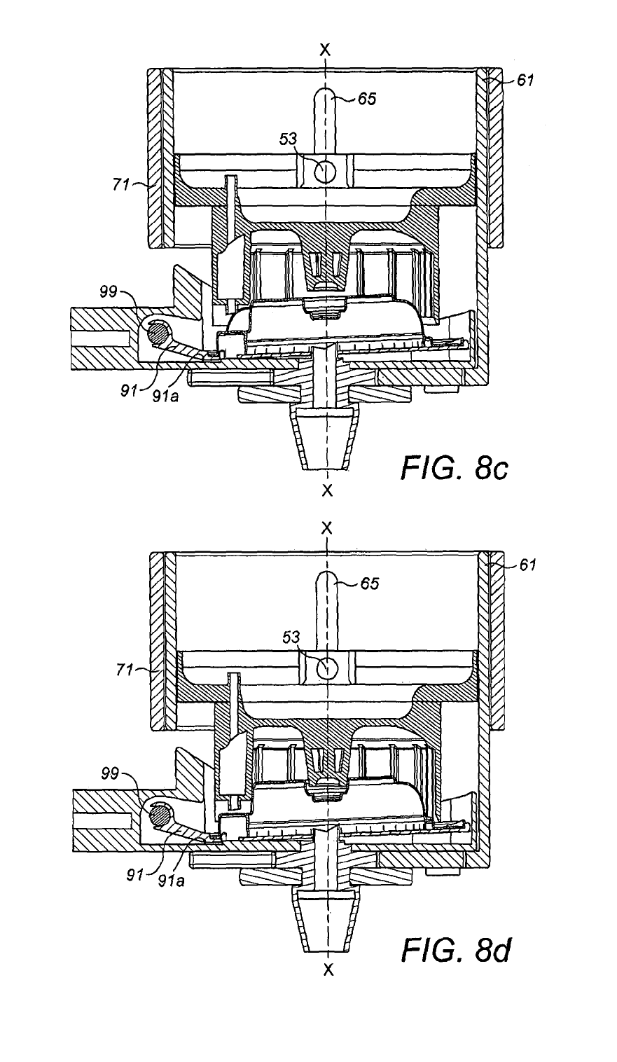

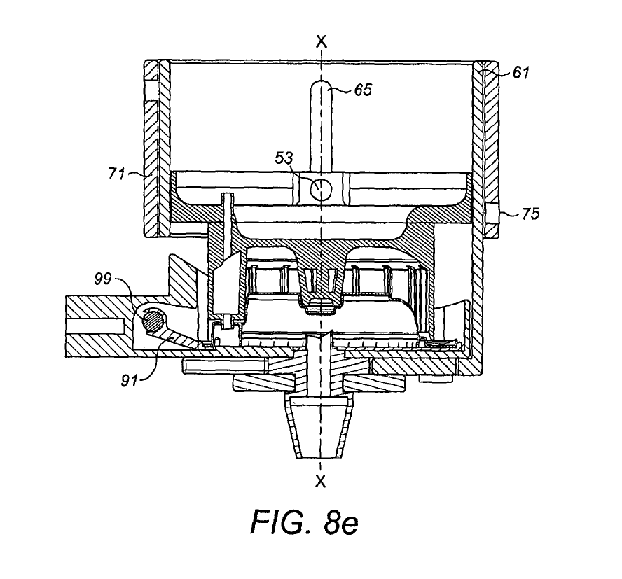

FIG. 8a is a cross-sectional view of the clamping mechanism showing the holder in the first position before piercing of the beverage cartridge;

FIGS. 8b to 8d are views similar to FIG. 8a showing the clamping mechanism and beverage cartridge during rotation of the holder from the first position towards the second position; and

FIG. 8e is a cross-sectional view similar to FIG. 8a showing the holder in the second position with the beverage cartridge pierced and clamped;

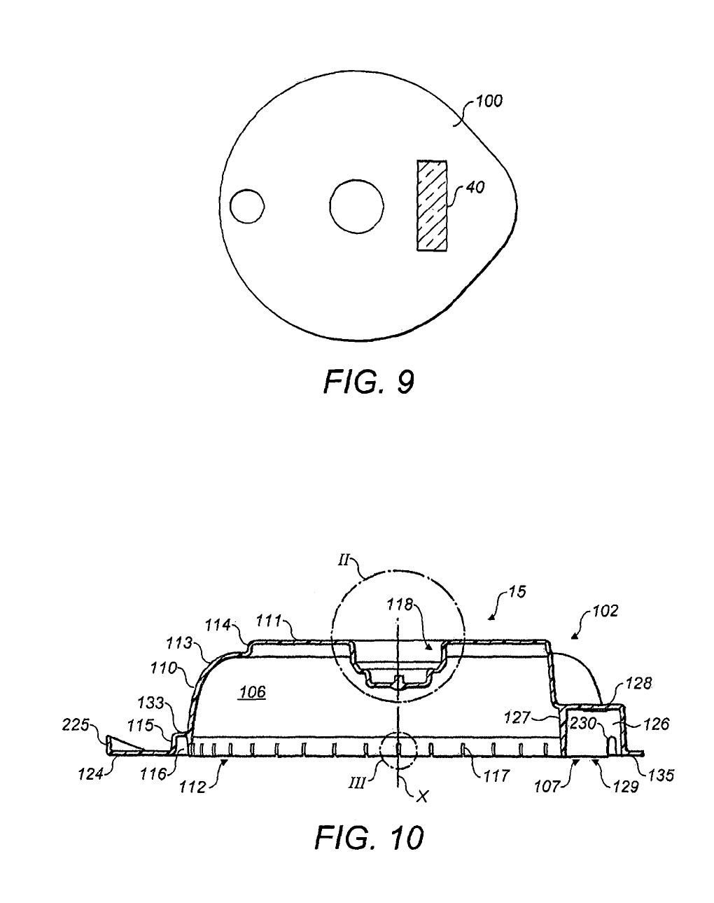

FIG. 9 is an underside plan view of a beverage cartridge for use in the clamping mechanism of the present disclosure;

FIG. 10 is a cross-sectional view of an outer member of the beverage cartridge of FIG. 9;

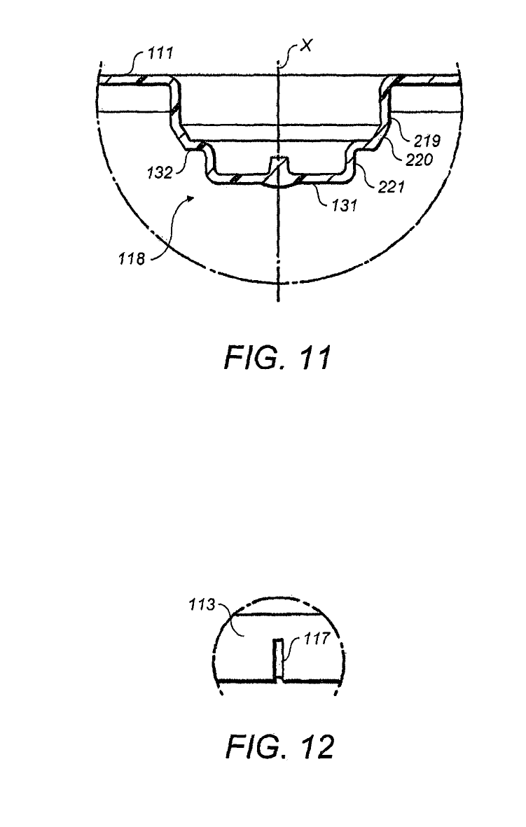

FIG. 11 is an enlarged cross-sectional view of a portion of FIG. 11 referenced II in FIG. 10;

FIG. 12 is an enlarged cross-sectional view of a portion of FIG. 11 referenced III in FIG. 10;

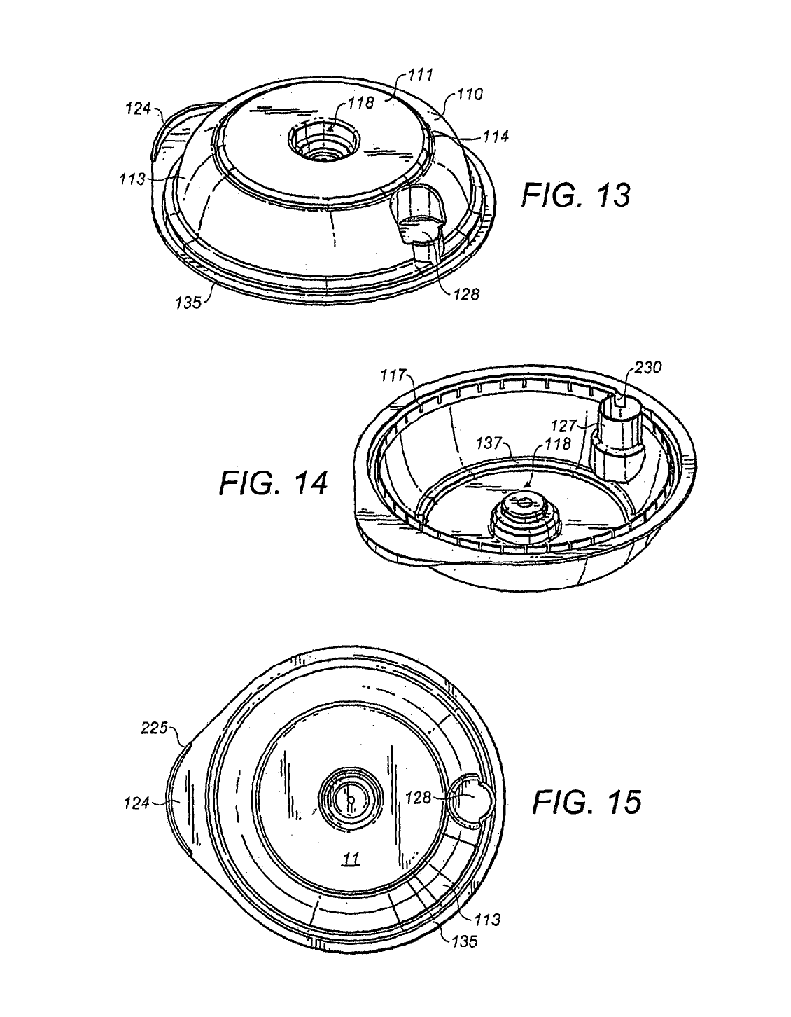

FIG. 13 is a perspective view from above of the outer member of FIG. 10;

FIG. 14 is a perspective view from underneath of the outer member of FIG. 10;

FIG. 15 is a plan view from above of the outer member of FIG. 10;

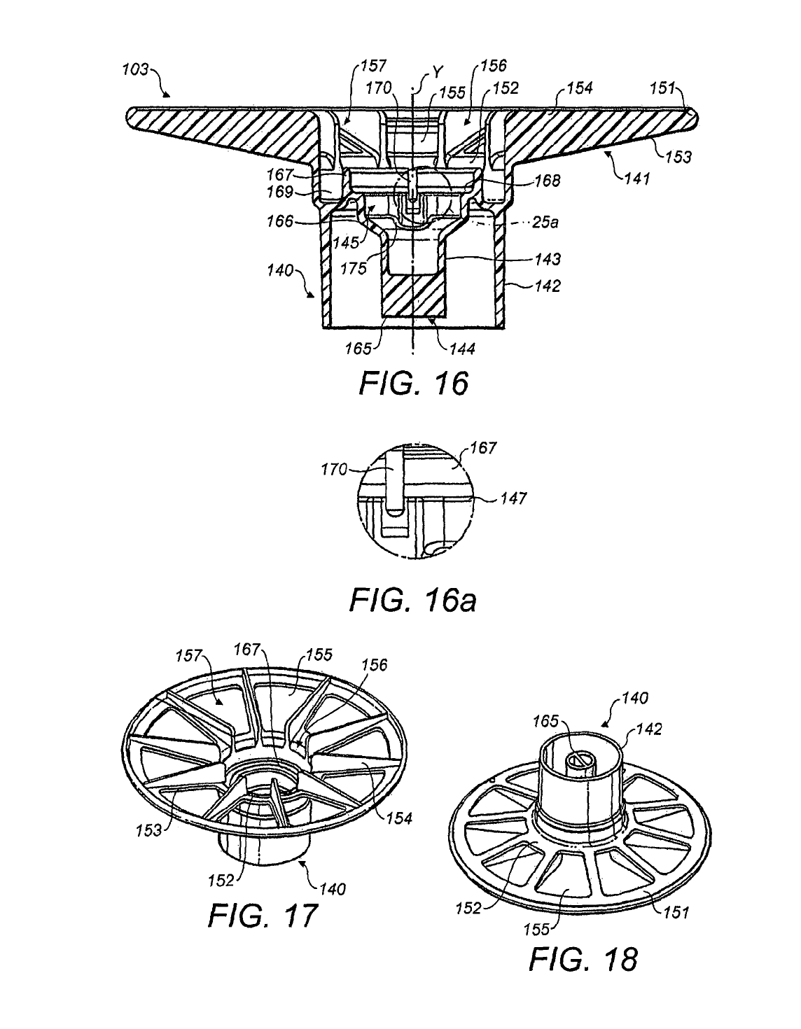

FIG. 16 is a cross-sectional view of an inner member of the beverage cartridge of FIG. 9;

FIG. 16a is an enlarged cross-sectional view of a portion of the inner member of, FIG. 16 referenced 25a in FIG. 16;

FIG. 17 is a perspective view from above of the inner member of FIG. 16;

FIG. 18 is a perspective view from underneath of the inner member of FIG. 16;

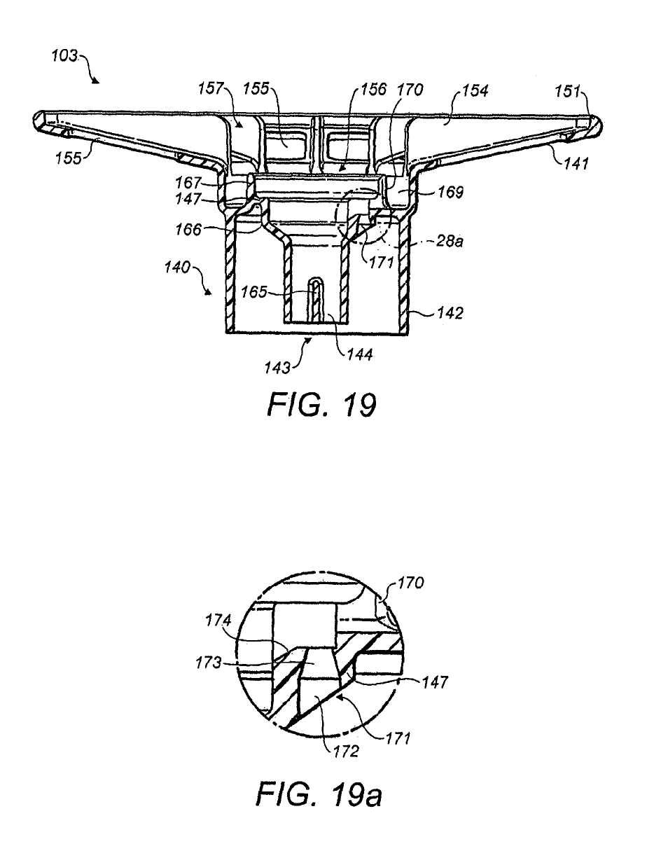

FIG. 19 is another cross-sectional view of the inner member of FIG. 16 sectioned at 90° to the section of FIG. 16;

FIG. 19a is an enlarged cross-sectional view of a portion of the inner member of FIG. 19 referenced 28a; and

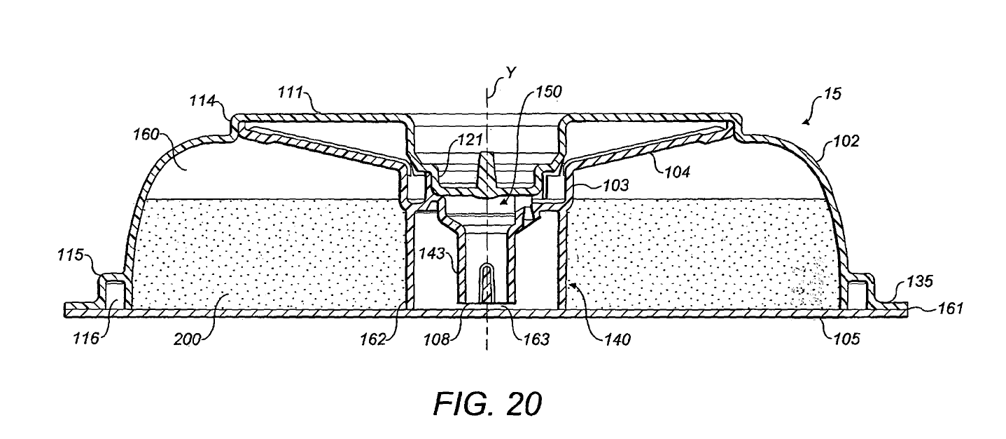

FIG. 20 is a cross-sectional view of the beverage cartridge of FIG. 9.

FIG. 1 shows a beverage preparation machine 1 having a housing 2 provided with a clamping mechanism 3. A serving area 5 is defined towards the front side of the housing 2 underneath the clamping mechanism 3. At the base of the serving area 5 is provided a cup stand 4.

As shown in FIG. 2, the clamping mechanism 3 comprises a clamp 30, a support 33 and a holder 37.

The support 33 comprises a fixed support part 32 which is securely mounted to the housing 2 and a rotatable support part 31 which is received within the fixed support part 32 so as to be axially and rotatably movable relative thereto.

The fixed support part 32 comprises a cylindrical body 71 at an upper end thereof and a dependent lower shelf 72 which is joined to the cylindrical body 71 by a downwardly extending leg 70. The lower shelf 72 is spaced apart from a lower edge of the cylindrical body 71 to define a mouth 73, the use of which will be described below. The lower shelf 72 is provided with a reader window 76. A forward portion of the lower shelf 72 is provided with an open-ended slot 74 which extends part way towards a back of the lower shelf 72. The cylindrical body 71 is provided with two arcuate guide slots 75 on opposed sides of the cylindrical body 71.

The rotatable support part 31 comprises a cylindrical body 61 at an upper end and a dependent lower shelf 62 at a lower end which is joined to the cylindrical body 61 by a downwardly extending leg 60. As with the lower shelf 72, an aperture 66 is provided forming a barcode aperture 66. A forward portion of the lower shelf 62 is provided with an open-ended slot 64. The lower shelf 62 is spaced apart from the lower edge of the cylindrical body 61 to define a mouth 63. The cylindrical body 61 is provided with two axial guide slots on opposed sides of the cylindrical body 61.

The clamp 30 comprises an upper cylindrical part 51 and a lower cylindrical part 52 which is of reduced diameter compared to the upper part 51. The upper part 51 is provided with two outwardly extending pegs 53 at opposed sides. As most clearly shown in FIG. 8a, the lower part 52 is generally hollow with a cylindrical lower rim 55. A partition is provided across the clamp 30 at about the mid-point and a downwardly directed extension 54 is provided extending therefrom, the use of which will be described below. A downwardly directed inlet piercer 86 is provided near a periphery of the lower part 52. The inlet piercer 86 comprises a hollow probe having a sharpened distal end and defining a bore through which water can pass. The inlet piercer 86 is formed integrally with, or may be mountable to, the lower part 52 of the clamp 30. The upper end of the inlet piercer 86 is fluidly connected to a water inlet 87 on an upper face of the clamp 30 by means of an internal passage in the clamp 30. In use a flexible tube can be connected to the water inlet 87 to provide a water supply to the clamp 30.

The clamp 30, rotatable support part 31 and fixed support part 32 are assembled by inserting the rotatable support part 31 within the fixed support part 32 and inserting the clamp 30 within the rotatable support part 31 such that the pegs 53 extend outwardly through both the axial guide slots 65 of the rotatable support part 31 and the arcuate guide slots 74 of the fixed support part 32. To ease assembly, the pegs 53 may be formed separately from the remainder of the upper part 51 and assembled therewith on assembly. For example, the upper part 51 may be provided with screw threaded holes that receive pegs or bolts or similar that have matching screw thread formations thereon. When assembled the rotatable support part 31 is able to rotate relative to the fixed support part 32 about a longitudinal axis X of the clamping mechanism 3 whilst the clamp 30 is able to move axially along the longitudinal axis relative to the fixed support part 32 and rotatable support part 31.

The holder 37 comprises a body 80, a cartridge holder 34 and an outlet nozzle assembly 36.

The body 80 has a generally cylindrical side wall 82 which defines a cavity 83. The body 80 is provided with a handle 81. A base of the body 80 at a bottom of the cavity 83 is provided with a barcode aperture 84 and an outlet piercer aperture 85. As best shown in FIG. 8a, the holder 35 is also provided with a pivot boss 99 to which the cartridge holder 34 may be pivotally mounted.

The outlet nozzle assembly 36 comprises at an upper side an outlet piercer 96 which has a central bore which connects through to the bottom of the outlet nozzle 97 at the bottom of the assembly 36 as shown in FIG. 8a. Immediately beneath the outlet piercer 96 is provided a rectangular ledge 95a which is raised relative to a larger rectangular lug 95b. Beneath the rectangular lug 95b is a cylindrical portion 95c that is recessed relative to the lug 95b. The outlet nozzle assembly 36 is joined to the body 80 by means of the outlet piercer aperture 85. To assemble the outlet nozzle assembly 36 with the body 80, the two parts are engaged to each other as is most clearly shown in FIG. 8a such that the rectangular ledge 95a is received and fixedly connected in the outlet piercer aperture 85. The parts may be fixed by welding, adhesive or similar means. In this position, the outlet piercer 96 projects upwardly within the cavity 83 of the body 80 and the rectangular lug 95b is positioned immediately below a lower face of the body 80. Due to the ledge 95a being rectangular and being fixed in the outlet piercer aperture 85, the outlet nozzle assembly 36 and the body 80 are rotationally fixed relative to one another.

The cartridge support 34 comprises a generally circular plate 90 with a dog-legged arm 91 depending therefrom. The distal end of the arm 91 is provided with a C-shaped clip 92. The arm 91 comprises an elbow 91a part-way along its length as shown in FIG. 8a. The plate 90 is provided with an aperture 93 which is rectangular in shape and matches the shape and size of the barcode aperture 84 of the body 80. The plate 90 is further provided with an elongated piercer slot 94 the use of which will be described further below. The cartridge support 34 is coupled to the body 80 by coupling the clip 92 to the pivot boss 99 of the body 80. The arm 91 has a dog-leg shape as best shown in FIG. 8a.

FIG. 3 illustrates the beverage preparation machine 1 and holder 37 in an uncoupled configuration with the holder 37 having a beverage cartridge 15 loaded therein. The beverage cartridge is described in more detail below with reference to FIGS. 9 to 20. With the holder 37 decoupled from the clamping mechanism as shown in FIG. 3 the guide slot 64 of the rotatable support part 31 is aligned with the guide slot 74 of the fixed support part 32. Thus, an opening is provided into which the outlet nozzle assembly 36 of the holder 37 may be inserted with a pushing action. On insertion of the holder 37 into the remainder of the clamping mechanism 3, as shown in FIGS. 4, 6c, 7a and 8a, a first position is obtained wherein the body 80 of the holder 37 is engaged with and supported on the lower shelf 62 of the rotatable support part 31. As shown in FIG. 8a and FIG. 6c, when moved into this first position the rectangular lug 95b slides in guide slot 64 of the rotatable support part 31 and forms a close fit therewith. The recessed cylindrical portion 95c of the outlet nozzle assembly 36 aligns with and is received within the guide slot 74 of the fixed support part 32 and the outlet nozzle 97 depends beneath the lower shelf 72 of the fixed support part 32. Therefore, while the diameter of the upper end of the nozzle 97 is greater than the width of the guide slot 74, the nozzle 97 does not impede relative rotation of the outlet nozzle assembly 36 and the fixed support part 32.

As shown in FIG. 8a, the beverage cartridge 15 is inserted into the holder 37 so as to rest on the plate 90 of the cartridge support 34 with its foil side lowermost. In this position, the beverage cartridge 15 is held at an inclined angle to the horizontal due to the contact of the elbow of the dogleg arm 91 against the base of the body 80.

FIGS. 7a to 7d and FIGS. 8a to 8e illustrate the relative movement of the parts during clamping of the beverage cartridge 15. Clamping is carried out by a user manually rotating the handle 81 about the longitudinal axis X of the clamping mechanism 3. In the illustrated embodiment the rotational movement required to fully clamp the beverage cartridge 15 is approximately 90°. In the first position when the holder 37 has first been inserted into the remainder of the clamping mechanism 3 the clamp 30 is fully contained within the cylindrical body 61 and cylindrical body 71 of the respective rotatable and fixed support parts 31, 32. As shown in FIG. 8a, the lower rim 55 of the clamp 50 does not project below the cylindrical bodies 61 and 71. This ensures that the mouths 63 and 73 of the rotatable and fixed support parts are unobstructed to allow easy insertion of the holder 37. In this position the pegs 53 are located towards an upper end of both the axial guide slots 65 and arcurate guide slots 75.

As the holder 37 starts to be rotated, the rotatable support part 31 is also forced to rotate due to the inter-engagement between the rectangular lug 95b of the outlet nozzle assembly 36 and the walls of the guide slot 64 of the shelf 62 of the rotatable support part 31. Since the pegs 53 are engaged in both the axial guide slot 65 and arcuate guide slot 75, this rotation of the rotatable support part 31 imparts a downward axial movement of the clamp 30 relative to the rotatable support part 31 and fixed support part 32 as the pegs 53 traverse downwardly along the axial guide slot 65 and arcurate guide slot 75 as shown in FIGS. 7b and 8b. As shown in FIGS. 7c and 7d, continued rotation of the holder 37 causes the clamp 30 to fully descend resulting in the lower part 52 of the clamp 50 moving downwardly such that the lower rim 55 is in close proximity to the base of the cavity 83 of the body 80. As shown in FIGS. 8b to 8e, this downward movement of the lower part 52 of the clamp 50 results in the clamp 30 engaging and displacing the beverage cartridge 15 and cartridge holder 35. This displacement is caused by contact firstly of the lower rim 55 with portions of the upper surface of the capsule 15 and then also later in the clamping operation as shown in FIG. 8d by engagement of the inward extension 54 with an upper recess of the beverage cartridge 15. The downward movement of the lower part 52 causes the cartridge support 34 to rotate such that when finally clamped the beverage cartridge 15 has been brought into a horizontal position with the plate 90 horizontal and in contact with the base of the cavity 83. This rotation of the plate 90 is accommodated by flexure of the doglegged arm 91 and rotation of the clip 92 about the pivot boss 99.

As seen from FIGS. 8a to 8e, the clamping movement results in the piercing of an inlet and an outlet in the beverage cartridge 15. The inlet is pierced through the upper surface of the cartridge and the outlet though the lower foil. Due to the fact that the inlet piercer 86 and outlet piercer 96 are part of the clamp 30 and holder 37 respectively and both are therefore rotating with the beverage cartridge 15 about the longitudinal axis X, resultant holes formed in the beverage cartridge 15 substantially match the outward shape of the piercer elements and are not formed as extended arcurate slots.

In the second, clamped position of FIGS. 7d and 8e, the holder 37 is firmly retained in the rotatable support 31 and fixed support part 32. This is most clearly seen in FIGS. 6a and 6b which illustrate that relative rotation of the holder 37 to the rotatable support part 31 results in the guide slots 64 and 74 no longer being aligned such that the outlet nozzle assembly 36 is firmly secured. Also, it can be seen from FIGS. 6a to 6c that rotation into the second position of FIG. 6a results in the barcode aperture 66 of the rotatable support part 31 being brought into alignment with the reader window 76 of the fixed support part 32. In addition, it will be noted that in this position the barcode aperture of the holder 37 is also aligned with these two apertures. This ensures that in the second clamped position, a barcode reader provided in the beverage preparation machine 1 is enabled to read a barcode which may be provided on the lower surface of the cartridge 15 at the position aligned with the barcode aperture 84.

Once dispensation of a beverage using the cartridge 15 has been completed then the holder 37 is unclamped by reversing the operation described above by rotating the handle 81 in the opposite direction. As the clamp 30 is disengaged from the beverage cartridge 15 the cartridge holder 34 springs back into its inclined orientation due to the biasing effect of the flexed dog-legged arm 91. Advantageously, the beverage cartridge 15 can be disposed directly into a waste receptacle by pulling the holder 37 out of the support 33 and upturning the holder 37. Thus the user is not required to touch or handle the beverage cartridge 15 itself after use.

The following description provides one example of a cartridge 15 which may be used with the clamping mechanism and in the system of the present disclosure. While this exemplar cartridge 15 is provided with an entrainer, for incorporating air into the beverage, other cartridges may not have such an entrainer. Other exemplar cartridges which may be used include those commercially available from Kraft Foods, Inc under the trade name Tassimo® T-discs® examples of which are described more fully in EP 1 440 909 and GB 2 416 480.

The cartridge 15 of FIGS. 9 to 20 generally comprises an outer member 102, an inner member 103 and a laminate 105. The outer member 102, inner member 103 and laminate 105 are assembled to form the cartridge 15 which has an interior 106 for containing one or more beverage ingredients, an inlet 107, an outlet 108 and a beverage flow path linking the inlet 107 to the outlet 108 and which passes through the interior 106. The inlet 107 and outlet 108 are initially sealed by the laminate 105 and are opened in use by piercing or cutting of the laminate 105.

The illustrated example of the cartridge 15 is particularly designed for use in dispensing espresso-style products such as roast and ground coffee where it is desirable to produce a crema.

As can be seen from FIG. 9, the overall shape of the cartridge 15 is generally circular or disc-shaped with the diameter of the cartridge 15 being significantly greater than its height. A major axis Y passes through the centre of the outer member as shown in FIG. 20. Typically the overall diameter of the outer member 102 is 74.5 mm±6 mm and the overall height is 16 mm±3 mm. Typically the volume of the cartridge 15 when assembled is 30.2 ml±20%.

The outer member 102 generally comprises a bowl-shaped shell 110 having a curved annular wall 113, a closed top 111 and an open bottom 112. The diameter of the outer member 102 is smaller at the top 111 compared to the diameter at the bottom 112, resulting from a flaring of the annular wall 113 as one traverses from the closed top 111 to the open bottom 112. The annular wall 113 and closed bottom 112 together define a receptacle having an interior 134.

A hollow inwardly directed cylindrical extension 118 is provided in the closed top 111 centred on the major axis X. As more clearly shown in FIG. 11, the cylindrical extension 18 comprises a stepped profile having first, second and third portions 219, 220 and 221. The first portion 219 is right circular cylindrical. The second portion 220 is frusto-conical in shape and is inwardly tapered. The third portion 221 is another right circular cylinder and is closed off by a lower face 131. The diameter of the first, second and third portion 219, 220 and 221 incrementally decreases such that the diameter of the cylindrical extension 118 decreases as one traverses from the top 111 to the closed lower face 131 of the cylindrical extension 118. A generally horizontal shoulder 132 is formed on the cylindrical extension 118 at the junction between the second and third portions 220 and 221.

An outwardly extending shoulder 133 is formed in the outer member 102 towards the bottom 112. The outwardly extending shoulder 133 forms a secondary wall 115 co-axial with the annular wall 113 so as to define an annular track forming a manifold 116 between the secondary wall 115 and the annular wall 113. The manifold 116 passes around the circumference of the outer member 102. A series of slots 117 are provided in the annular wall 113 level with the manifold 116 to provide gas and liquid communication between the manifold 116 and the interior 134 of the outer member 102. As shown in FIG. 10, the slots 117 comprise vertical slits in the annular wall 113. Between twenty and forty slots are provided. In the embodiment shown thirty-seven slots 117 are provided generally equi-spaced around the circumference of the manifold 16. The slots 117 are preferably between 1.4 and 1.8 mm in length. Typically the length of each slot 117 is 1.6 mm representing 10% of the overall height of the outer member 102. The width of each slot 117 is between 0.25 and 0.35 mm. Typically, the width of each slot 117 is 0.3 mm. The width of the slots 117 is sufficiently narrow to prevent the beverage ingredients passing there through into the manifold 116 either during storage or in use.

An inlet chamber 126 is formed in the outer member 102 at the periphery of the outer member 102. A cylindrical wall 127 is provided, as most clearly shown in FIG. 10, which defines the inlet chamber 126 within, and partitions the inlet chamber 126 from, the interior 134 of the outer member 102. The cylindrical wall 127 has a closed upper face 128 which is formed on a plane perpendicular to the major axis Y and an open lower end 129 co-planar with the bottom 12 of the outer member 102. The inlet chamber 26 communicates with the manifold 116 via two slots 230 as shown in FIG. 10. Alternatively, between one and four slots may be used to communicate between the manifold 116 and the inlet chamber 126.

A lower end of the outwardly extending shoulder 133 is provided with an outwardly extending flange 135 which extends perpendicularly to the major axis Y. Typically the flange 135 has a width of between 2 and 4 mm. A portion of the flange 135 is enlarged to form a handle 124 by which the outer member 102 may be held. The handle 124 is provided with an upturned rim 225 to improve grip.

The outer member 102 is formed as a single integral piece from high density polyethylene, polypropylene, polystyrene, polyester, or a laminate of two or more of these materials.

The inner member 103, as shown in FIGS. 16 to 19, comprises an annular frame 141 and a downwardly extending cylindrical funnel 140. A major axis Y passes through the centre of the inner member 103 as shown in FIG. 16.

As best shown in FIGS. 17 and 18, the annular frame 141 comprises an outer rim 151 and an inner hub 152 joined by ten equi-spaced radial spokes 153. The inner hub 152 is integral with and extends from the cylindrical funnel 140. Filtration apertures 155 are formed in the annular frame 141 between the radial spokes 153. A filter 104 is disposed on the annular frame 141 so as to cover the filtration apertures 155. The filter is preferably made from a material with a high wet strength, for example a non-woven fibre material of polyester. Other materials which may be used include a water-impermeable cellulosic material, such as a cellulosic material comprising woven paper fibres. The woven paper fibres may be admixed with fibres of polypropylene, polyvinyl chloride and/or polyethylene.

As shown in the cross-sectional profile of FIG. 16, the inner hub 152 is located at a lower position than the outer rim 151, resulting in the annular frame 141 having-a sloping lower profile.

The upper surface of each spoke 153 is provided with an upstanding web 154 which divides a void space above the annular frame 141 into a plurality of passages 157. Each passage 157 is bounded on either side by a web 154 and on a lower face by the filter 104. The passages 157 extend from the outer rim 151 downwardly towards, and open into, the cylindrical-funnel 140 at openings 156 defined by the inner extremities of the webs 154.

The cylindrical funnel 140 comprises an outer tube 142 surrounding an inner discharge spout 143. The outer tube 142 forms the exterior of the cylindrical funnel 140. The discharge spout 143 is joined to the outer tube 142 at an upper end of the discharge spout 143 by means of an annular flange 147. The discharge spout 143 comprises an inlet 145 at an upper end which communicates with the openings 156 of the passages 157 and an outlet 144 at a lower end through which the prepared beverage is discharged into a cup or other receptacle. The profile of the discharge spout 43 comprises a stepped profile with a distinct dog-leg 166 near an upper end of the tube 143.

As shown in FIG. 16, the discharge spout 143 is provided with a partition 165 which extends part way up the discharge spout 143 from the outlet 144. The partition 165 helps to prevent the beverage spraying and/or splashing as it exits the discharge spout 143.

A rim 167 is provided upstanding from the annular flange 147 joining the outer tube 142 to the discharge spout 143. The rim 167 surrounds the inlet 145 to the discharge spout 143 and defines an annular channel 169 between the rim 167 and the upper portion of the outer tube 142. The rim 167 is provided with an inwardly directed shoulder 168. At one point around the circumference of the rim 167 an aperture 170 is provided in the form of a slot which extends from an upper edge of rim 167 to a point marginally below the level of the shoulder 168 as most clearly shown in FIGS. 16 and 16a. The slot has a width of 0.64 mm.

An air inlet 171 is provided in annular flange 147 circumferentially aligned with the aperture 170 as shown in FIGS. 16 and 16a. The air inlet 171 comprises an aperture passing through the flange 147 so as to provide communication between a point above the flange 147 and the void space below the flange 147 between the outer tube 142 and discharge spout 143. Preferably, and as shown, the air inlet 171 comprises an upper frusto-conical portion 173 and a lower cylindrical portion 172. The air inlet 171 is typically formed by a mould tool such as a pin. The tapered profile of the air inlet 171 allows the mould tool to be more easily removed from the moulded component. The wall of the outer tube 142 in the vicinity of the air inlet 171 is shaped to form a chute leading from the air inlet 171 to the inlet 145 of the discharge spout 143. As shown in FIG. 16a, a canted shoulder 174 is formed between the air inlet 171 and the chute to ensure that the jet of beverage issuing from the slot 170 does not immediately foul on the upper surface of the flange 147 in the immediate vicinity of the air inlet 171.

The inner member 103 may be formed as a single integral piece from polypropylene or a similar material as described above.

The laminate 105 is formed from two layers, a first layer of aluminium and a second layer of cast polypropylene. The aluminium layer is between 0.02 and 0.07 mm in thickness. The cast polypropylene layer is between 0.025 and 0.065 mm in thickness. In one embodiment the aluminium layer is 0.06 mm and the polypropylene layer is 0.025 mm thick. This laminate 105 is particularly advantageous as it has a high resistance to curling during assembly. As a result the laminate 105 may be pre-cut to the correct size and shape and subsequently transferred to the assembly station on the production line without undergoing distortion. Consequently, the laminate 108 is particularly well suited to welding. Other laminate materials may be used including PET/Aluminium/PP, PE/EVOH/PP, PET/metallised/PP and Aluminium/PP laminates. Roll laminate stock may be used instead of die cut stock.

The cartridge 15 may be closed by a rigid or semi-rigid lid instead of a flexible laminate 105.

Assembly of the cartridge 15 is as described in EP 1 440 909 and EP 1 796 516.

In use water, under pressure, enters the cartridge 15 through the inlet 107 into the inlet chamber 126. From there the water is directed to flow through the slots 117 and round the manifold 116 and into the filtration chamber 160 of the cartridge 1 through the plurality of slots 117. The water is forced radially inwardly through the filtration chamber 160 and mixes with the beverage ingredients 200 contained therein. The water is at the same time forced upwardly through the beverage ingredients 200. The beverage formed by passage of the water through the beverage ingredients 200 passes through the filter 104 and filtration apertures 155 into the passages 157 lying above the annular frame 141.

Beverage in the radial passages 157 flows downwardly along the passages 157 formed between the webs 154 and through the openings 156 and into the annular channel 169 of the cylindrical funnel 140. From the annular channel 169 the beverage is forced under pressure through the aperture 128 by the back pressure of beverage collecting in the filtration chamber 160 and passages 157. The beverage is thus forced through aperture as a jet and into an expansion chamber formed by the upper end of the discharge spout 143. As shown in FIG. 20, the jet of beverage passes directly over the air inlet 171. Passage of the beverage through the restriction of the aperture causes the pressure of the beverage to be reduced. As the beverage enters the discharge spout 143 the pressure of the beverage is still relatively low. As a result air is entrained into the beverage stream in the form of a multitude of small air bubbles as air from an exterior of the cartridge 15 is drawn up through the air inlet 171. The jet of beverage issuing from the aperture is funneled downwards to the outlet 144 where the beverage is discharged into the outlet tube 120 described above and from there on into a receptacle such as a cup where the air bubbles form the desired crema. Thus, the aperture and the air inlet 171 together form an air entrainer which acts to entrain air into the beverage.

1: A clamping mechanism for a beverage preparation machine comprising:
a support;
a holder for a beverage cartridge; and
a clamp;
the holder capable of being coupled to and decoupled from the support;
wherein the holder is rotatable about a first axis of the clamping mechanism between:
i) a first position, in which the holder is able to be coupled to or decoupled from the support and the holder and clamp are relatively spaced apart in the direction of the first axis; and
ii) a second position in which the holder is retained to the support and the holder and clamp are relatively close to one another in the direction of the first axis such that a beverage cartridge held in use in the holder is clamped between the holder and the clamp;
wherein the clamping mechanism further comprises an inlet piercer for forming an inlet in the beverage cartridge, wherein the inlet piercer forms part of, or is coupled to, the clamp and is able to rotate with the holder about the first axis.

2: A clamping mechanism as claimed in claim 1 wherein the support comprises a fixed support part and a rotatable support part; the holder being able to be coupled to or decoupled from the rotatable support part.

3: A clamping mechanism as claimed in claim.2 wherein:
i) the clamp is coupled to the rotatable support part so as to be rotational fixed thereto but able to move relative thereto in the direction of the first axis;
ii) the rotatable support part is rotatable relative to the fixed support part but fixed relative thereto in the direction of the first axis; and
iii) the clamp is coupled to the fixed support part so as to be movable relative thereto both in the direction of the first axis and rotationally.

4: A clamping mechanism as claimed in claim 2 wherein:
i) the rotatable support part comprises one or more axial guide slots orientated in the direction of the first axis and the clamp comprises one or more pegs which are slidingly received in the one or more axial guide slots;
ii) the fixed support part comprises one or more curved guide slots in which the one or more pegs of the clamp are slidingly received.

5: A clamping mechanism as claimed in claim 1 wherein the holder is rotatable about the first axis in a plane substantially perpendicular to the first axis and wherein during rotation between the first and second positions the holder remains in said plane without moving along the first axis.

6: A clamping mechanism as claimed in claim 1 wherein the holder and clamp are coupled to the support such that on rotation of the holder between the first and second positions the clamp is moved in the direction of the first axis.

7: A clamping mechanism as claimed in claim 1 wherein the clamping mechanism further comprises a beverage cartridge support which forms a part of, or is coupled to, the holder; the beverage cartridge support being movable between:
i) a loading position in which, with the holder coupled to the support in the first position, the beverage cartridge support is inclined relative to a plane substantially perpendicular to the first axis; and
ii) a clamped position in which, with the holder coupled to the support in the second position, the beverage cartridge support is in the plane substantially perpendicular to the first axis.

8: A clamping mechanism as claimed in claim 1 wherein the inlet piercer is off-set from the centre of the clamp such that the inlet piercer follows an arc path as the clamp rotates about the first axis.

9: A clamping mechanism as claimed in claim 1 wherein, the clamping mechanism further comprises an outlet piercer for forming an outlet in the beverage cartridge, wherein the outlet piercer forms part of, or is coupled to, the holder so as to rotate with the holder between the first and second positions.

10: A method of clamping a beverage cartridge in a beverage preparation machine comprising the steps of:
inserting the beverage cartridge into a holder;
coupling the holder to a support;
rotating the holder and inlet piercer about a first axis;
said rotation causing the holder and a clamp to move relatively closer to one another in the direction of the first axis so as to engage the beverage cartridge with the clamp and so clamp the cartridge between the clamp and the holder; and
piercing an inlet in the cartridge using an inlet piercer which rotates with the clamp about the first axis.

11: A method as claimed in claim 10 wherein the holder is rotated in a plane substantially perpendicular to the first axis and wherein during rotation the holder remains in said plane without moving along the first axis.

12: A method as claimed in claim 10 wherein the beverage cartridge is initially supported in the holder in an inclined orientation such that with the holder coupled to the support the beverage cartridge is inclined relative to a plane substantially perpendicular to the first axis; wherein on rotation of the holder the clamp forces the beverage cartridge to rotate about a second axis perpendicular to the first axis so to lie in the plane substantially perpendicular to the first axis.

13: A method as claimed in claim 12 wherein the holder further comprises an outlet piercer, the inlet piercer and outlet piercer piercing opposite sides of the beverage cartridge, the holder comprising an inlet piercer.

14: A clamping mechanism for a beverage preparation machine comprising:
a support;
a holder for a beverage cartridge; and
a clamp;
the holder capable of being coupled to and decoupled from the support and comprising a beverage cartridge support;
the holder being rotatable about a first axis of the clamping mechanism between:
i) a loading position in which the holder and clamp are relatively spaced apart in the direction of the first axis wherein the beverage cartridge support of the holder is inclined relative to a plane substantially perpendicular to the first axis; and
ii) a clamped position in which the holder and clamp are relatively close to one another in the direction of the first axis wherein the beverage cartridge support has been moved into the plane substantially perpendicular to the first axis.

15: A clamping mechanism as claimed in claim 14 wherein:
i) the holder comprises a body having a base and a side wall so as to define a cavity; and
ii) the beverage cartridge support is located within the cavity.

16: A clamping mechanism as claimed in claim 15 wherein the beverage cartridge support is pivotally coupled to the holder so as to be rotatable between the loading and clamped positions.

17: A clamping mechanism as claimed in claim 14 wherein the beverage cartridge support ie biased into the position in which it is inclined relative to the plane substantially perpendicular to the first axis.

18: A clamping mechanism as claimed in claim 14 wherein the holder further comprises an outlet piercer extending upwardly from the base.

19: A beverage preparation system comprising a beverage preparation machine and a beverage cartridge, wherein the beverage preparation machine comprises a clamping mechanism as claimed in claim 1.

20: A beverage preparation system comprising a beverage preparation machine and a beverage cartridge, wherein the beverage preparation machine comprises a clamping mechanism as claimed in claim 14.
